(19) United States
(12) Patent Application Publication
(10) Pub. No.: US 2025/0071879 A1
(43) Pub. Date: Feb. 27, 2025

(54) LIGHT SENSOR BASED COMMISSIONING OF LIGHTING SYSTEMS

(71) Applicant: Tridonic Portugal, Unipessoal LDA, Villa Nova de Gaia (PT)

(72) Inventors: Kari Severinkangas, Villa Nova de Gaia (PT); Antonio Sousa, Valbom Gondomar (PT); Joao Azevedo, Braga (PT); Jorge Filipe, Porto (PT); Carlos Silva, Paredes (PT)

(73) Assignee: Tridonic Portugal, Unipessoal LDA, Villa Nova de Gaia (PT)

(21) Appl. No.: 18/721,345

(22) PCT Filed: Dec. 7, 2022
(86) PCT No.: PCT/EP2022/084735

§ 371 Date: Jun. 18, 2024

(30) Foreign Application Priority Data
Jan. 25, 2022 (EP) 22153075.1

(51) Int. Cl. H05B 47/175; H05B 47/11

(52) U.S. Cl. CPC H05B 47/199; H05B 47/11

(57) ABSTRACT

Disclosed is a method (1) of commissioning of a plurality of luminaires (2). The respective luminaire (2) comprises a light sensor (21), and means (22) for communication to a central device (3). The method (1) comprises predefining (11) a commissioning sequence (41) of the plurality of luminaires (2) in a building layout plan (4); modulating (12) a light input of the light sensor (21) of the respective luminaire (2) in accordance with the predefined commissioning sequence (41); informing (13) the central device (3) of the light input modulation of the respective luminaire (2) using a network address of the respective luminaire (2) if an assessment as to an intensity of the light input of the light sensor (21) of the respective luminaire (2) crosses a predefined threshold; and associating (14) the network address and the respective luminaire (2) in the building layout plan (4) in accordance with the predefined commissioning sequence (41). This makes sensor-based luminaire commissioning more straightforward.

### CROSS REFERENCE TO RELATED APPLICATIONS

The present application is the U.S. national stage application of international application PCT/EP2022/084735 filed Dec. 7, 2022, which international application was published on Aug. 3, 2023 as International Publication WO 2023/143790 A1. The international application claims priority to European Patent Application No. 22153075.1 filed Jan. 25, 2022.

### TECHNICAL FIELD

The present disclosure relates to luminaire commissioning in lighting systems, and in particular to a method of commissioning a plurality of luminaires, and to a corresponding lighting system.

### BACKGROUND ART

Luminaire commissioning, i.e., the process of assuring that the luminaires of a lighting system of a building or industrial plant are installed and addressable as planned, usually requires technicians to navigate between and within rooms and to interact with the respective luminaire using a commissioning device such as a handheld phone or using light modulation means.

For example, WO 2017/036747 A1 discloses sensor-based luminaire commissioning using a commissioning device.

For example, EP 2 364 574 B1 discloses sensor-based luminaire commissioning using light modulation means. More specifically, the patent document discloses a central unit advertising an address to be assigned over a lighting control bus, a technician allocating the advertised address to a respective luminaire by modulating a light input on a light sensor of the respective luminaire, and the central unit detecting a completed address allocation via bus feedback. In summary, a system-centric commissioning process is disclosed.

### SUMMARY

In view of the background art, the present disclosure is aimed at providing a more straightforward sensor-based luminaire commissioning.

The objective is achieved by the embodiments as defined by the appended independent claims. Preferred embodiments are set forth in the dependent claims and in the following description and drawings.

A first aspect of the present disclosure relates to a method of commissioning a plurality of luminaires. A respective luminaire of the plurality of luminaires comprises a light sensor, and means for communication to a central device. The method comprises predefining a commissioning sequence of the plurality of luminaires in a building layout plan; modulating a light input of the light sensor of the respective luminaire in accordance with the predefined commissioning sequence; informing the central device of the light input modulation of the respective luminaire using a network address of the respective luminaire if an assessment as to an intensity of the light input of the light sensor of the respective luminaire crosses a predefined threshold; and associating the network address and the respective luminaire in the building layout plan in accordance with the predefined commissioning sequence.

The light sensor may comprise an ambient light sensor.

The central device may comprise one of: a network edge device of the plurality of luminaires, and a cloud server device reachable via the network edge device.

The means for communication may comprise wireless communication means.

The means for communication may comprise wireline communication means.

The wireline communication means may comprise a lighting control bus.

The building layout plan may comprise an identifier and a position of the respective luminaire.

The position of the respective luminaire may comprise one of: a relative position, and an absolute position.

The predefining the commissioning sequence may comprise automatically predefining the commissioning sequence in accordance with obstructions in the building layout plan.

The modulating the light input of the light sensor of the respective luminaire may comprise directing a light source onto the light sensor.

The modulating the light input of the light sensor of the respective luminaire may comprise shading the light sensor.

The associating the network address and the respective luminaire may comprise associating the network address and the identifier of the respective luminaire.

The method may further comprise indicating a commissioning success by the respective luminaire.

A second aspect of the present disclosure relates to a lighting system, comprising a plurality of luminaires, respectively comprising a light sensor, and means for communication to a central device, and being configured for commissioning according to a method of the first aspect or any of its implementations.

The lighting system may further comprise the central device.

The technical effects and advantages described in relation with the method of the first aspect equally apply to the lighting system of the second aspect being configured for commissioning according to the method of the first aspect.

### BRIEF DESCRIPTION OF DRAWINGS

The above-described aspects and implementations will now be explained with reference to the accompanying drawings, in which the same or similar reference numerals designate the same or similar elements.

The features of these aspects and implementations may be combined with each other unless specifically stated otherwise.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a lighting system in accordance with the present disclosure;

FIG. 2 illustrates a method of commissioning a plurality of luminaires in accordance with the present disclosure; and

FIG. 3 illustrates a building layout plan in accordance with the present disclosure;

### DETAILED DESCRIPTIONS OF DRAWINGS

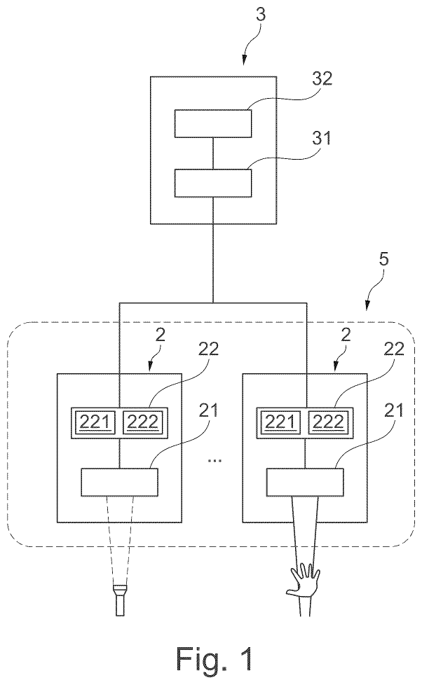

FIG. 1 illustrates a lighting system 5 in accordance with the present disclosure.

As indicated by the dashed outline, the lighting system 5 at least comprises a plurality of luminaires 2. In particular, the respective luminaire 2 of the plurality of luminaires 2 may comprise an LED-based light source.

The respective luminaire 2 comprises a light sensor 21. In particular, the light sensor 21 may comprise an ambient light sensor configured to sense an ambient light level of the respective luminaire 2.

A sensor as used herein may refer to a component of a lighting system being configured to provide sensor readings. A light sensor is accordingly configured to provide sensor readings in terms of light levels.

FIG. 1 further indicates that a light input of the light sensor 21 may be modulated. For example, this may comprise directing 121 a light source onto the light sensor 21 as is indicated in connection with the leftmost luminaire 2, and/or shading 122 of the light sensor 21 as is indicated in connection with the rightmost luminaire 2.

The respective luminaire 2 further comprises means 22 for communication to a central device 3, which may in turn include wireless communication means 221 such as a Bluetooth-enabled radio interface, a Bluetooth Low Energy (BLE)-enabled radio interface etc., and/or wireline communication means 222 such as a lighting control bus, for example a Digital Addressable Lighting Interface (DALI) bus.

The lighting system 5 may further comprise the central device 3. The central device 3 may include one of: a network edge device 31 of the plurality of luminaires 2, and a cloud server device 32 reachable via the network edge device 31.

A network edge device or (network) gateway as used herein may refer to a network device located at a network edge of a lighting system and interfacing with an external network, such as a building network or the Internet.

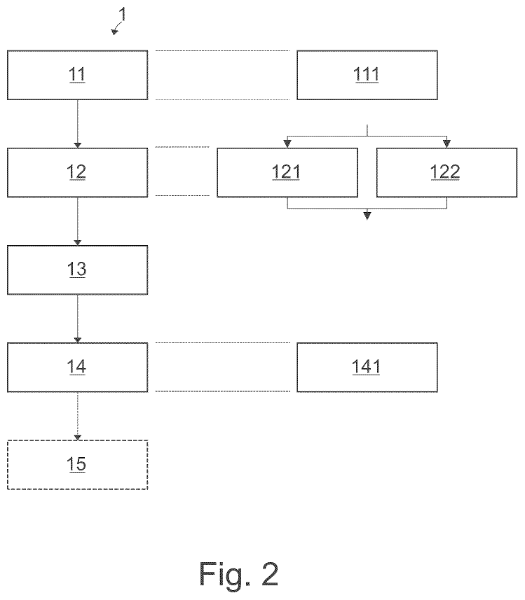

The luminaires 2 of the plurality of luminaires 2 are respectively configured for commissioning according to a method 1 of the first aspect or any of its implementations, as will be described in more detail in connection with FIG. 2 below.

FIG. 2 illustrates a method 1 of commissioning a plurality of luminaires 2 in accordance with the present disclosure.

The method 1 implies the plurality of luminaires 2 as described in more detail in connection with FIG. 1 above.

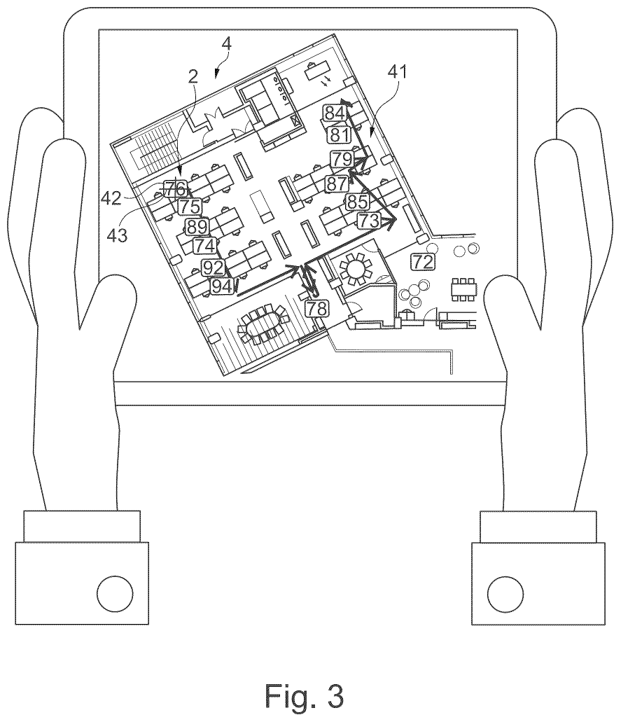

The method 1 comprises a step of predefining 11 a commissioning sequence 41 of the plurality of luminaires 2 in a building layout plan 4, which will be described in more detail in connection with FIG. 3 below.

In particular, the predefining 11 may comprise automatically predefining 111 the commissioning sequence 41 in accordance with obstructions 44 in the building layout plan 4, as will be described in more detail in connection with FIG. 3 below.

The method 1 further comprises a step of modulating 12 a light input of the light sensor 21 of the respective luminaire 2 in accordance with the predefined commissioning sequence 41. In other words, the technician may visit the plurality of luminaires 2 in the order defined by the commissioning sequence 41 in accordance with the building layout plan 4.

As already mentioned in connection with FIG. 1, the modulating 12 may comprise directing 121 a light source onto the light sensor 21, such as by pointing 121 a light output of an electric torch onto the light sensor 21 of the respective luminaire 2. Alternatively or additionally, the modulating 12 may comprise shading 122 the light sensor 21, such as by holding a hand in between an ambient light source (not shown) and the light sensor 21.

The method 1 further comprises a step of informing 13 the central device 3 of the light input modulation of the respective luminaire 2 using a network address of the respective luminaire 2 if an assessment as to an intensity of the light input of the light sensor 21 of the respective luminaire 2 crosses (i.e., exceeds, or falls below) a predefined threshold. Thereby, the central device 3 obtains sensor notifications from each of the plurality of luminaires 2 in the order defined by the commissioning sequence 41.

For example, no matter if directing 121 a light output of an electric torch onto or shading 122 the light sensor 21 of the respective luminaire 2, such an assessment may relate to the intensity as such (i.e., absolute light level) and/or may relate to a steepness of a change of the intensity (i.e., time rate of a change of the light level). So depending on the particular approach of assessment, the corresponding predefined threshold may comprise an absolute light level or a time rate of change of light level.

In a straightforward implementation, this assessment of crossing a threshold level or sharp rise/drop does not have to be carried out in the respective luminaire 2 itself. Rather, the light sensor 21 associated with the respective luminaire 2 may continuously or in predefined discrete time steps send light level (i.e., intensity) information to the central device 3 or even a handheld device (connected thereto) so as to determine the respective luminaire 2 in which the change of intensity of the light input has been sensed.

Note that the light input does not carry any further information going beyond the simple presence of light, such as modulation information, so that the described method 1 can also be used in connection with legacy luminaries, which are simply provided with a light sensor but do not have further intelligence in order to decode information carried in the signal.

The network address may have been assigned to the respective luminaire 2 during manufacture, for example.

The method 1 further comprises a step of associating 14 the network address and the respective luminaire 2 in the building layout plan 4 in accordance with the predefined commissioning sequence 41, in particular by associating 141 the network address and an identifier 42 of the respective luminaire 2 comprised in the building layout plan 4. For example, the identifier 42 may be a numeric value that is unique among the plurality of luminaires 2.

As the commissioning sequence 41 is predefined and known, the sensor notifications (including respective network addresses) from each of the plurality of luminaires 2 (i.e., real devices) can be linked to the corresponding symbols (i.e., virtual devices) in the building layout plan 4, which in turn are respectively associated with corresponding identifiers 42 and positions 43.

In summary, the technician may make the luminaires 2 enter into commissioning mode one after another, following a real-world path/route across the building or at least a floor, which path/route is known by the central device 3 that also receives the commissioning activation information from the respective luminaire 2 upon light input modulation.

For the sake of completeness, the method 1 may further comprise indicating 15 a commissioning success by the respective luminaire 2. For example, the indicating 15 may be achieved by illuminating a light source of the respective luminaire 2, such as at least one light emitting device (LED).

FIG. 3 illustrates a building layout plan 4 in accordance with the present disclosure.

The building layout plan 4 may be hosted and maintained by the central device 3, and may be accessed by a technician responsible for the commissioning. For example, a tablet device having network connectivity to the central device 3 may be used to access the building layout plan 4, as is indicated in FIG. 3.

The building layout plan 4 comprises the plurality of luminaires 2, which may respectively be indicated by luminaire symbols (e.g., boxes), and may comprise an identifier 42 and a position 43 of the respective luminaire 2. According to the example of FIG. 3, the identifier 42 of the respective luminaire 2 may be represented by the numeric value of the corresponding luminaire symbol, and the position 43 of the respective luminaire 2 may be represented by the position of the corresponding luminaire symbol within the building layout plan 4.

The position 43 of the respective luminaire 2 may comprise one of: a relative position, and an absolute position. In other words, in the building layout plan 4 the respective luminaires 2 have their absolute positions or their positions relative to one another defined. Luminaires 2 that need to be commissioned may be selected by the technician or by the central device 3 in a particular selection order that may be termed the commissioning sequence 41.

That is to say, the technician may be enabled to manually predefine the commissioning sequence 41, for example via the above-mentioned tablet device.

Alternatively, the commissioning sequence 41 may be automatically predefined 111 in accordance with obstructions 44 in the building layout plan 4, such as walls, chasms or immobile furniture. For example, the plurality of luminaires 2 may be connected by an arbitrary path/route, such as a shortest possible route that visits each of the plurality of luminaires 2 exactly once (i.e., in accordance with a solution to the known travelling salesman problem), wherein the path/route is not allowed to touch any of the obstructions 44. Thereby, sensor-based luminaire commissioning may be automated and made more straightforward.

As shown in FIG. 3, the building layout plan 4 may further comprise the resulting commissioning sequence 41 for use by the technician in the commissioning procedure.

1. A method (1) of commissioning a plurality of luminaires (2),
a respective luminaire (2) of the plurality of luminaires (2) comprising
a light sensor (21), and
means (22) for communication to a central device (3);
the method (1) comprising
predefining (11) a commissioning sequence (41) of the plurality of luminaires (2) in a building layout plan (4);
modulating (12) a light input of the light sensor (21) of the respective luminaire (2) in accordance with the predefined commissioning sequence (41);
informing (13) the central device (3) of the light input modulation of the respective luminaire (2) using a network address of the respective luminaire (2) if an assessment as to an intensity of the light input of the light sensor (21) of the respective luminaire (2) crosses a predefined threshold; and
associating (14) the network address and the respective luminaire (2) in the building layout plan (4) in accordance with the predefined commissioning sequence (41).

2. The method (1) of claim 1,
the assessment relating to the intensity as such, and
the predefined threshold comprising an absolute light level.

3. The method (1) of claim 1,
the assessment relating to a steepness of a change of the intensity; and
the predefined threshold comprising a time rate of change of light level.

4. The method (1) of claim 1, the light sensor (21) comprising an ambient light sensor.

5. The method (1) of claim 1, the central device (3) comprising one of:
a network edge device (31) of the plurality of luminaires (2), and
a cloud server device (32) reachable via the network edge device (31).

6. The method (1) of claim 1, the means (22) for communication comprising wireless communication means (221).

7. Currently Amended) The method (1) of claim 1, the means (22) for communication comprising wireline communication means (222).

8. The method (1) of claim 7, the wireline communication means (222) comprising a lighting control bus.

9. The method (1) of claim 1,
the building layout plan (4) comprising an identifier (42) and a position (43) of the respective luminaire (2).

10. The method (1) of claim 9, the position (43) of the respective luminaire (2) comprising one of:
a relative position, and
an absolute position.

11. The method (1) of claim 1, predefining (11) the commissioning sequence (41) comprising
automatically predefining (111) the commissioning sequence (41) in accordance with obstructions (44) in the building layout plan (4).

12. The method (1) of claim 1, modulating (12) the light input of the light sensor (21) of the respective luminaire (2) comprising
directing (121) a light source onto the light sensor (21).

13. The method (1) of claim 1, modulating (12) the light input of the light sensor (21) of the respective luminaire (2) comprising
shading (122) the light sensor (21).

14. The method (1) of claim 1, associating (14) the network address and the respective luminaire (2) comprising
associating (141) the network address and the identifier (42) of the respective luminaire (2).

15. The method (1) of claim 1, further comprising indicating (15) a commissioning success by the respective luminaire (2).

16. A lighting system (5), comprising
a plurality of luminaires (2),
respectively comprising a light sensor (21), and means (22) for communication to a central device (3); and
being configured for commissioning according to a method (1) of claim 1.

17. The lighting system (5) of claim 16, further comprising the central device (3).
